(19) United States
(12) Patent Application Publication
(10) Pub. No.: US 2009/0077065 A1
(43) Pub. Date: Mar. 19, 2009

(54) Method and system for information searching based on user interest awareness

(75) Inventors: Yu Song, Pleasanton, CA (US); Doreen Cheng, San Jose, CA (US); Swaroop Kalasapur, Sunnyvale, CA (US); Alan Messer, Los Gatos, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/900,847

(22) Filed: Sep. 13, 2007

(51) Int. Cl. G06F 17/30

(52) U.S. Cl. 707/5; 707/E17.017

(57) ABSTRACT

A method and system are provided for information searching based on user interest awareness. Information that represents user interest is obtained. One or more key terms are obtained from the user interest information. Then, a given query is enhanced based on one or more of the key terms for generating an enhanced query for searching.

### FIELD OF THE INVENTION

The present invention relates to systems for providing access to information and in particular to systems for providing access to information by query searching.

### BACKGROUND OF THE INVENTION

With the proliferation of information available on the Internet and the World Wide Web (Web), there has been an increasing interest in access to information on the Web using search engines. Users regularly utilize search engines (e.g., google.com) to manually enter queries and then inspect through the multitude of search result documents that are typically returned.

Some Web searching approaches supplement user queries by extracting keywords from the current document that the user is viewing, to increase the search result relevance. A refinement involves extracting keywords from the vicinity of words that a user highlights in a document and forming a query as a combination of the extracted keywords and the highlighted words, to increase the search result relevance. However, these approaches are limited to document-oriented applications, and assume that the keywords the user highlights are related to the topic of the current document, which may not be the case.

Another Web searching approach relies on a common ontology tree, such as Concept Map, or a common directory (e.g., Open Directory as in www.dmoz.org). When a user specifies a query, the query is used in the ontology tree or directory comparison to identify potential knowledge domains that a user may be interested in. The user is asked to select among the identified domains, based on which domain knowledge keywords are used to enhance Web searching. However, this requires user involvement and places a burden on the user to select domains.

### BRIEF SUMMARY OF THE INVENTION

The present invention provides a method and system for information searching based on user interest awareness. One embodiment involves obtaining information that represents user interest, determining one or more key terms from said user interest information, and enhancing a query based on one or more of the key terms for generating an enhanced query for searching.

In one implementation, determining one or more key terms further includes determining one or more key terms from said user interest information based on the query. This involves determining a similarity between terms in the query and terms in the user interest information, and selecting one or more terms having the highest similarity among the terms in the user interest information, as said one or more key terms.

In another implementation, determining one or more key terms further includes selecting one or more terms having highest similarity among the terms in the user interest information, determining terms of highest relevance to the query among the selected one or more terms, and choosing among the terms of highest similarity and highest relevance, as said one or more key terms. Searching is then performed based on the enhanced query.

These and other features, aspects and advantages of the present invention will become understood with reference to the following description, appended claims and accompanying figures.

### BRIEF DESCRIPTION OF THE DRAWINGS

FIG. 1 shows an architecture for searching based on user interest awareness, according to an embodiment of the present invention.

FIG. 2 shows an example implementation of an architecture for searching based on user interest awareness, according to the present invention.

FIG. 3 shows an example operation scenario for a client process generating an enhanced (supplemented) query based on user interest awareness, according to the present invention.

FIG. 4 shows an example query enhancement process based on user interest awareness, according to the present invention.

FIG. 5 shows an architecture for searching based on user interest awareness involving multiple client modules, according to an embodiment of the present invention.

FIG. 6 shows another architecture for query enhancement and searching based on user interest awareness, according to an embodiment of the present invention.

In the drawings, like references refer to like elements.

### DETAILED DESCRIPTION OF THE INVENTION

The present invention provides a method and system for searching based on user interest awareness. One embodiment involves determining user interest and supplementing a user query based on user interest information. Searching is then performed by causing execution of the supplemented query on a search engine, thereby increasing the likelihood of search result relevance to the user query.

The user interest information may be based on, e.g., history of user access to information such as documents and/or information being viewed by the user, documents and/or information previously viewed by the user, user interaction with content, history of searches by the user, etc. The user interest information may also be based on, e.g., user context such as user profile, previous content of interest to the user, content is user media collection such as a video collection, explicitly provided user interest information, etc.

In one example, the user interest information may include a list of interest key terms (e.g., words, phrases) automatically extracted from previous user queries and search result inspections. For example, it is likely that terms on a Web page document that the user is viewing on a browser on a client module, or has previously viewed/visited, represent information of interest to the user. Further, terms in search queries submitted by the user generally represent the current interests of the user. Such terms can be used to determine related terms of interest in, e.g., a log of user activities such as interaction with Web pages, access content, prior queries, user profile, and the like. Capturing the user interest information, and supplementing a user query based on user interest information, is preferably automatically performed without a need for user involvement.

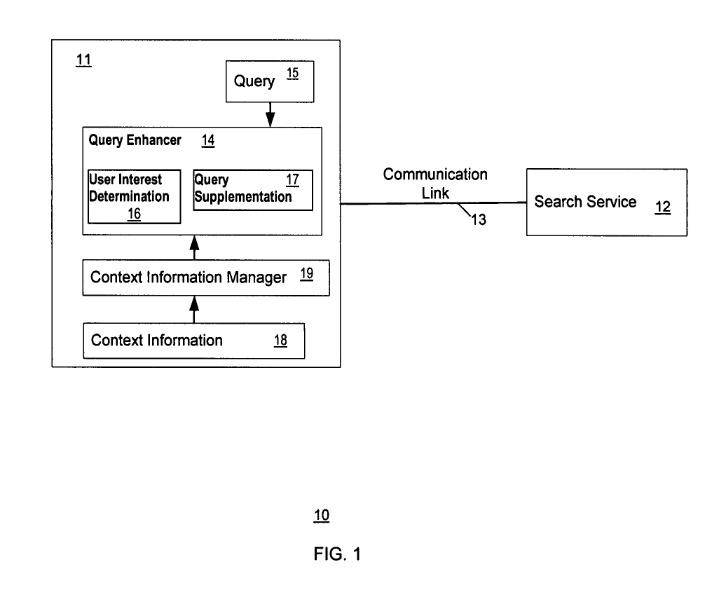

FIG. 1 shows an architecture 10 for searching based on user interest awareness, according to an embodiment of the present invention. A client 11 can communicate with a searching service 12 such as a search engine on the Web, via a communication link 13 such as the Internet. The client 11 can comprise a module in an electronic device such as a computer, a consumer electronics (CE) device, an appliance, etc.

The client 11 receives a query 15 such as a user query (e.g., text). A query enhancer 14 supplements the query 15 to generate an enhanced (supplemented) query for searching via the search service 12. The query enhancer includes a user interest determination module 16 that determines user interest information, and a query supplementation module 17 which supplements the user query 15 based on user interest information. The enhanced user query is sent from the client 11 to the search service 12 for searching and the search results are returned to the client 11. The search results can be pre-processed (e.g., filtered) before being presented to the user.

The user interest determination module 16 determines user interests based on user context information 18 which is managed by a context information manager 19. In one operation scenario, the context information manger 19 creates a table for storing context information 18. When a user views a document via the client 11, the context information manager 19 extracts terms from that document and generates an entry in the table identifying the document, the extracted terms, and a relevancy value representing the degree of importance in each extracted term within the document.

When a new query 15 arrives, the user interest determination module 16 obtains query terms from the user query 15. The query supplementation module 17 then determines a similarity between the query terms and the terms in the context information table 19. An example similarity computation is a cosine-based similarity measure as known in the art. The query supplementation module 17 selects a few documents with the highest similarity from the context information table 19. The documents with the highest similarity likely provide information (e.g., terms) of higher interest to the user.

For each selected document, the query supplementation module 17 selects a few terms with the highest relevancy value corresponding to the selected document, from the context information table 19. The query supplementation module 17 then combines the selected terms with the user query to obtain a supplemented query for searching by the search service 12. Example implementations are described in more detail further below.

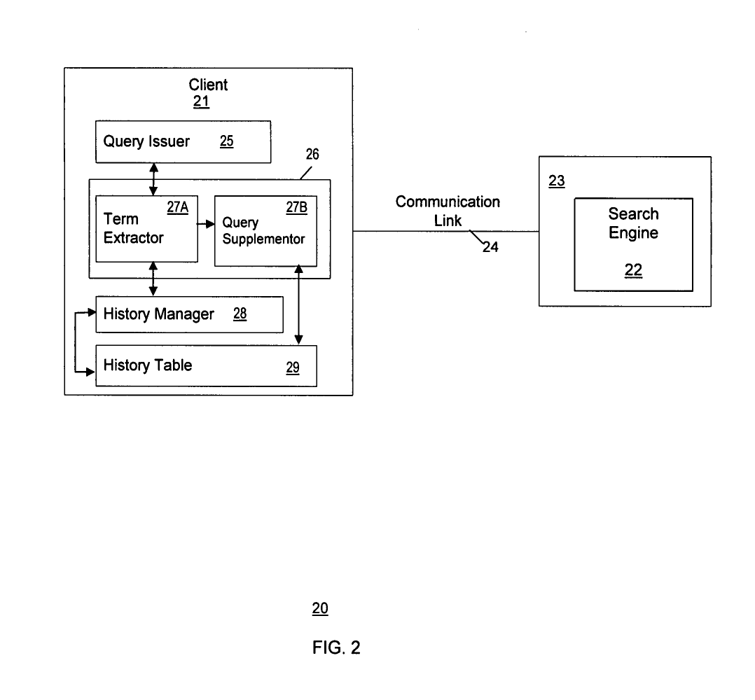

FIG. 2 shows one example implementation as an architecture 20, for searching based on user interest awareness, according to the present invention. A client (module/device) 21 can communicate with a searching service 22 such as a search engine in a network 23 such as the Web, via a communication link 24 such as the Internet. The client 21 can comprise a software module in a device or an electronic device such as a computer, a CE device, an appliance, etc.

The client 21 includes a query issuer 25, a query enhancer 26 and a history manager 28 that manages a user history table 29 for user context information. The query issuer 25, such as a browser, provides a user query for searching. When a user types in a query, the browser sends the query to the history manager 28. The query enhancer 26 includes a term extractor 27A and a query supplementor 27B.

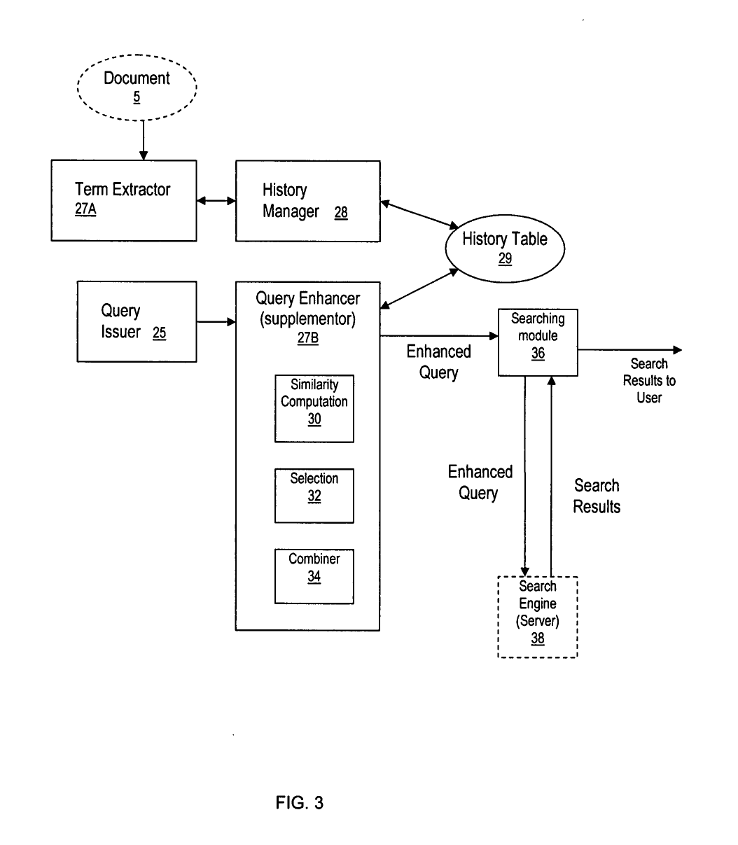

FIG. 3 shows an example operation scenario for the client 21 in generating an enhanced (supplemented) query. The term extractor 27A analyzes a document 5 currently viewed by the user (e.g., a search result in response to a previous query), and extracts terms from that document 5. The extracted terms are provided to the history manger 28 to store therein. The history manager 28 optionally sets the rules for term extraction. Term extraction may include deleting stop-words, using a maximum number of words for a term, selecting certain terms such as noun phrases only, etc. In one implementation, extraction of terms involves tokenization of the query into words and phrases, and extracting tokens. For example a query of “samsung camera price” can be extracted into terms as: “samsung”, “camera”, “price”, “samsung camera”, and “camera price.” Extraction rules describe what terms should be extracted. For example, a rule may specify that all stop-words, such as “is”, “what”, “how”, “when”, should be removed because they do not have any semantic significance.

After receiving the extracted terms, the history manager 28 updates the history table 29 with the extracted terms (described further below). When the query issuer 25 issues a query, the query is processed by the query supplementor 27B, which accesses the history table 29 to compute the similarity between the query terms and the extracted terms stored in the history table 29. Based on the computed similarity, the query supplementor 27B selects the most relevant terms, and supplements the query with one or more of them.

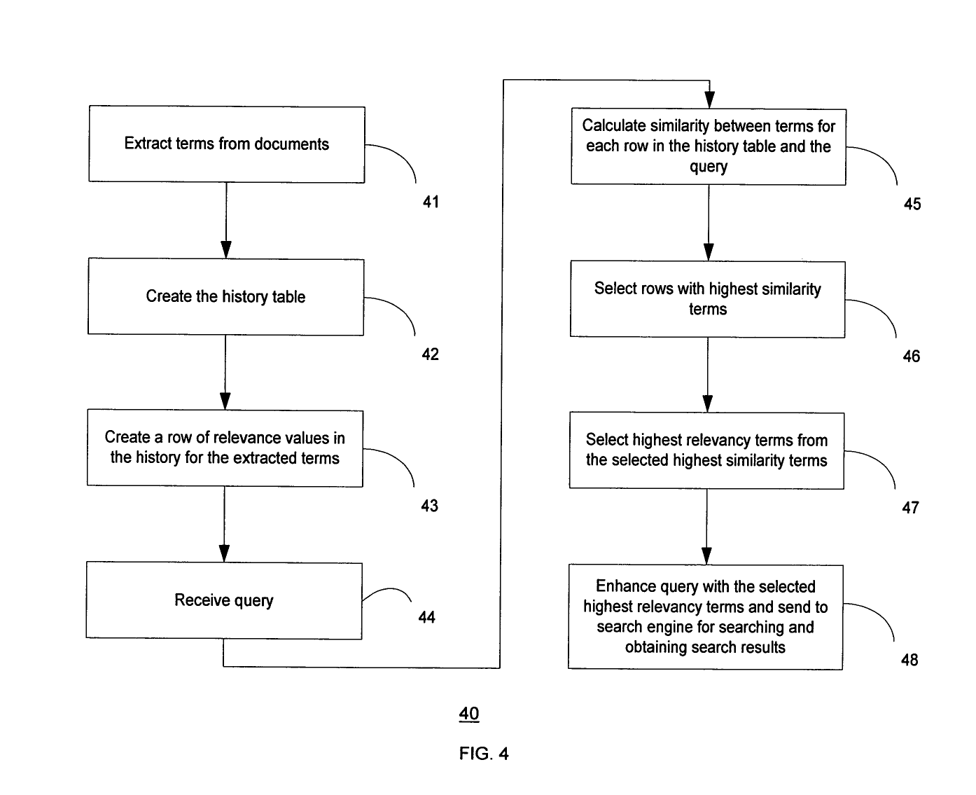

FIG. 4 shows an example query enhancement process 40 according to the present invention, including the following steps:
Step 41: The term extractor extracts terms from a document.
Step 42: The history manager creates the history table if it has not been created yet.
Step 43: The history manager creates a row in the history table for the viewed document and columns for extracted terms corresponding to the document for that row, and updates all entries in the history table. This updating process also then updates the score of each key term for each document in the history table. The score of the term can be, e.g., a TF-IDF (term frequency-inversed document frequency) weighting function, described further below. As described in more detail further below, a table entry at a row and a column contains information about how relevant the term at that column is to the interest of the user in the document at that row.
Step 44: The query issuer issues a query.
Step 45: A similarity computation module 30 (FIG. 3) calculates the similarity between the query terms and the extracted terms in the history table corresponding to each row therein.
Step 46: A selection module 32 (FIG. 3) selects rows (documents) with the most similar extracted terms to the query terms.
Step 47: The selection module 32 selects extracted terms of highest relevance for the selected rows.
Step 48: A combiner module 34 (FIG. 3) combines the selected terms to the original query terms and generates an enhanced query for a searching module 36 (FIG. 3) to send to a search engine on a server 38 via, e.g., the Internet, for searching and returning search results.

The search results can be displayed via the query issuer (e.g., browser) for user review. In another example, the history manager may be configured to perform steps 45-47 instead of the query supplementor.

Table 1 below shows an example of the history table. Each row represents a document Dᵢ (i=1, . . . , n) and each column represents a term Tⱼ (j=1, . . . , m) extracted from one or more of the documents.

TABLE 1
History Table

| | T₁ | T₂ | T₃ | . . . | Tₙ |
|---|---|---|---|---|---|
| D₁ | F₁₁ | F₁₂ | F₁₃ | | F₁ₙ |
| D₂ | F₂₁ | F₂₂ | F₂₃ | | F₂ₙ |
| D₃ | F₃₁ | F₃₂ | F₃₃ | | F₃ₙ |
| . . . | | | | | |
| Dₘ | Fₘ₁ | Fₘ₂ | Fₘ₃ | | Fₘₙ |

The table entry at the i^{th} row and j^{th} column, Fᵢⱼ, in Table 1 contains information about how relevant the term Tⱼ is to the interest of the user in the document Dᵢ. In one example, a relevance value Fᵢⱼ can be based on frequency of occurrence and/or location (e.g., title, subtitle, emphasized body, non-emphasized body, etc.), of the term Tⱼ in the document Dᵢ. In another example, a relevance value Fᵢⱼ can be computed using the well known TF-IDF weighting function. In this TF-IDF example, the corpus in all the documents referenced in the table and the TF is computed from the current document being accessed. TF-IDF weight is a statistical measurement for evaluating the importance of a word in a document in a collection or corpus. In one implementation, the importance of a word is proportional to the number of appearances of the word in the document, offset by the frequency of the word in the corpus.

When a user views a document via the client, the term extractor extracts terms from that document and the history manager generates an entry in the history table identifying the document, the extracted terms, and a relevancy value (e.g., a TF-IDF value for an extracted term) representing the degree of importance in each extracted term within the document. Given that the document is being viewed by the user (e.g., the result of a user search query), it is a heuristic indication of a user interest, wherein the TF-IDF value of a term in the document also represents the user interest in that term.

When a new query arrives, the history manager determines a similarity between the query terms and the terms in the history table. The history manager selects d documents with the highest similarity from the history table 29 (d is a non-negative integer, e.g., 1 or 2). The selected documents with the highest similarity likely provide information (e.g., terms) of higher interest to the user.

For each selected document, the history manager selects t terms with the highest relevancy value corresponding to the selected document from the history table (t is a non-negative integer, e.g., 2 or 3). The query supplementation module then combines the selected terms with the query to obtain a supplemented query for searching by a search engine.

For example, a user has been browsing on the Web for the price of a Samsung camera. The user is particularly interested in the price of a Samsung camera, and therefore, “comparison” as a term appears many times in his browser history and, therefore, in the history table. Next time when the user issues the query “Samsung camcorder price”, the history manager measures the similarity of this query in relation to the terms in the history table, and determines that it is very similar to “samsung”, “camera”, “price”, “comparison”, in the history table. Because “comparison” is not a term that is in the query of “samsung camcorder price”, the term “comparison” is selected from the history and added to the original query “samsung camcorder price” by the query enhancer, to generate the enhanced query “samsung camcorder price comparison.”

The size of the history table should be selected based on such factors as memory capacity, available storage space, sufficient capture of extracted terms for representing user interests during a reasonable time period (e.g. a day, a week, a month, etc.). Table 2 below shows another example of the history table, which allows maintaining the size of the history table while capturing information (e.g., extracted terms in viewed documents) representing the changing interests of the user. The history manger further implements an aging function that stores aging values Aᵢ associated with each row/document in Table 2.

TABLE 2
History Table

| Document | Aging | T₁ | T₂ | T₃ | . . . | Tₙ |
|---|---|---|---|---|---|---|
| D₁ | A₁ | F₁₁ | F₁₂ | F₁₃ | | F₁ₙ |
| D₂ | A₂ | F₂₁ | F₂₂ | F₂₃ | | F₂ₙ |
| D₃ | A₃ | F₃₁ | F₃₂ | F₃₃ | | F₃ₙ |

. . .

| | | | | | |
|---|---|---|---|---|---|
| Dₘ | Aₘ | Fₘ₁ | Fₘ₂ | Fₘ₃ | Fₘₙ |

When an i^{th} row representing a document Dᵢ has been in Table 2 for a time period P based on an aging value Aᵢ, then that i^{th} row is deleted from Table 2. The aging function can be as simple as a counter. When a row/document is added to Table 2, the counter is set to a certain value, e.g., P=1000. Periodically, the counter is decremented by a pre-defined value, e.g., 1. The length of the period P depends on application, e.g. 1 day, 1 week, 1 month, etc. When a row counter reaches 0 (e.g., Aᵢ=0), the corresponding row (e.g., i^{th} row) is deleted from Table 2.

Alternatively, Aᵢ can be a timestamp indicating the time when the corresponding document Dᵢ is accessed by the user. When the time duration of the document Dᵢ in the table is longer than a certain pre-defined length, the i^{th} row is deleted from Table 2. The value of the pre-defined length depends on application and the system storage capacity, e.g. a week, a month, etc.

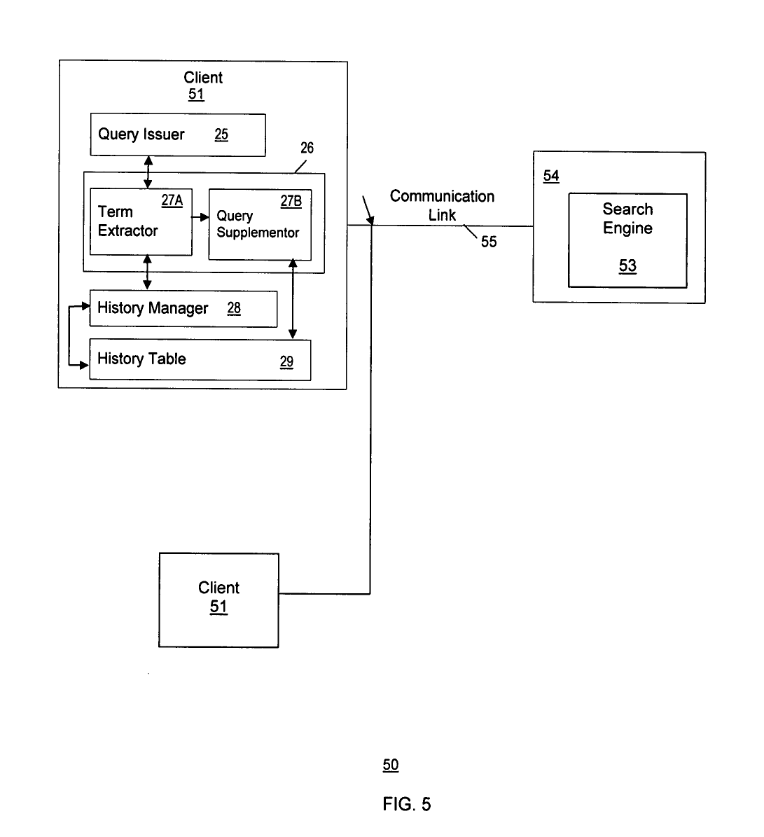

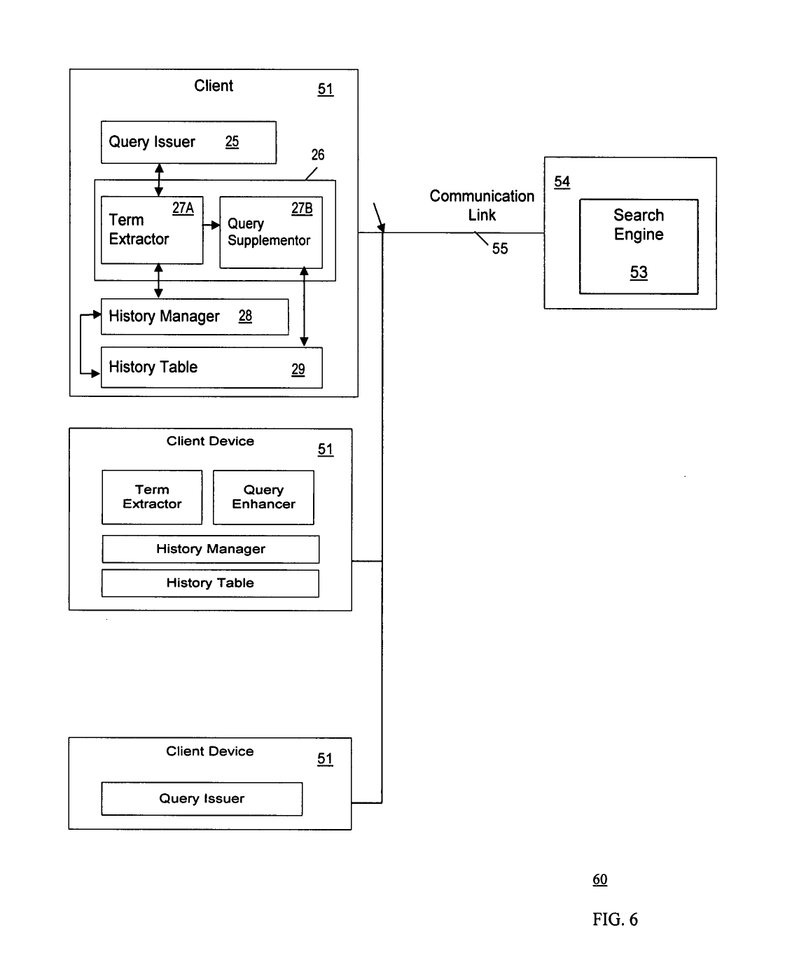

FIG. 5 shows another architecture 50 according to an embodiment of the present invention, showing multiple client devices 51. At least one of the client devices 51 implements information searching based on user interest awareness, (e.g., as in the client device 21 in FIG. 2) according to the present invention. The client devices 51 may be connected via a local area network (LAN) 52, which connects to the searching engines 53 on the Web 54 via the communication link 55. Further, as shown by the example architecture 60 in FIG. 6, the query enhancer, the history manager, the history table, the term extractor and the query issue, can reside in one client device or in multiple client devices as long as they are connected, and are connected to the client device where the query issuer (e.g., browser) resides. There is essentially no restriction in the type of searching tools and applications, and the burden on the user for directing the search is reduced.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method for information searching, comprising:
obtaining information that represents user interest;
determining one or more key terms from said user interest information; and
enhancing a query based on one or more of the key terms for generating an enhanced query for searching.

2. The method of claim 1 wherein enhancing a query further includes combining the query with one or more of the key terms.

3. The method of claim 1 wherein obtaining information that represents user interest further includes determining user interest information based on user context.

4. The method of claim 1 wherein obtaining information that represents user interest further includes determining user interest information based on history of user access to information.

5. The method of claim 1 wherein determining one or more key terms further includes determining one or more key terms from said user interest information based on the query.

6. The method of claim 5 wherein determining one or more key terms further includes determining a similarity between terms in the query and terms in the user interest information.

7. The method of claim 6 wherein determining one or more key terms further includes selecting one or more terms having highest similarity among the terms in the user interest information, as said one or more key terms.

8. The method of claim 6 wherein determining one or more key terms further includes:
selecting one or more terms having highest similarity among the terms in the user interest information;
determining terms of highest relevance to the query, among the selected one or more terms; and
choosing among terms of highest similarity and highest relevance, as said one or more key terms.

9. The method of claim 8 wherein:
the user interest information includes a document of interest to the user; and
determining terms of highest relevance to the query includes determining one or more terms of highest relevance to the query among the one or more selected terms based on frequency of occurrence and/or location of the selected one or more terms in a document.

10. The method of claim 1 further including causing execution of the enhanced query on a search engine for obtaining search results.

11. The method of claim 10 wherein the search engine is implemented on a server, and enhancing the query is performed by a client.

12. The method of claim 11 wherein the server is implemented on the Internet and the client connects to the Internet for communicating with the search engine for executing the search and retuning search results to the client.

13. An apparatus for information searching, comprising:
an information manager configured for obtaining information that represents user interest;
a term selector configured for determining one or more key terms from said user interest information; and
an enhancer configured for enhancing a query based on one or more of the key terms for generating an enhanced query for searching.

14. The apparatus of claim 13 wherein the enhancer is configured for combining the query with one or more of the key terms.

15. The apparatus of claim 13 wherein the information manager is configured for obtaining information that represents user interest by determining user interest information based on user context.

16. The apparatus of claim 13 wherein the information manager is configured for obtaining information that represents user interest by determining user interest information based on history of user access to information.

17. The apparatus of claim 13 wherein the term selector is further configured for determining one or more key terms from said user interest information based on the query.

18. The apparatus of claim 17 further including a similarity computation module configured for determining a similarity between terms in the query and terms in the user interest information.

19. The apparatus of claim 18 wherein the term selector is further configured for selecting one or more terms having highest similarity among the terms in the user interest information, as said one or more key terms.

20. The apparatus of claim 18 wherein the term selector is further configured for selecting one or more terms having highest similarity among the terms in the user interest information, determining terms of highest relevance to the query, among the selected one or more terms, and choosing among terms of highest similarity and highest relevance, as said one or more key terms.

21. The apparatus of claim 18 wherein the user interest information includes a document of interest to the user, such that the term selector is further configured for determining terms of highest relevance to the query by determining one or more terms of highest relevance to the query among the one or more selected terms based on frequency of occurrence and/or location of the selected one or more terms in a document.

22. The apparatus of claim 13 wherein the enhancer is configured for causing execution of the enhanced query on a search engine for obtaining search results.

23. The apparatus of claim 22 wherein the search engine is implemented on a server that the apparatus can connect to via a communication line.

24. A client module for information searching, comprising:
an information manager configured for maintaining information that represents user interest in a storage module;
a term selector configured for determining one or more key terms from said user interest information;
an enhancer configured for enhancing a query based on one or more of the key terms for generating an enhanced query for searching; and
a searching module configured for sending the enhanced query to a searching server via a communication link for searching and obtaining search results.

25. The client module of claim 24 wherein the enhancer is configured for combining the query with one or more of the key terms.

26. The client module of claim 24 wherein the information manager is configured for obtaining information that represents user interest by determining user interest information based on user context.

27. The client module of claim 24 wherein the information manager is configured for obtaining information that represents user interest by determining user interest information based on history of user access to information.

28. The client module of claim 24 wherein the term selector is further configured for determining one or more key terms from said user interest information based on the query.

29. The client module of claim 28 further including a similarity computation module configured for determining a similarity between terms in the query and terms in the user interest information.

30. The client module of claim 29 wherein the term selector is further configured for selecting one or more terms having highest similarity among the terms in the user interest information, as said one or more key terms.

31. The client module of claim 29 wherein the term selector is further configured for selecting one or more terms having highest similarity among the terms in the user interest information, determining terms of highest relevance to the query, among the selected one or more terms, and choosing among terms of highest similarity and highest relevance, as said one or more key terms.

32. The client module of claim 31 wherein the user interest information includes a document of interest to the user, such that the term selector is further configured for determining terms of highest relevance to the query by determining one or more terms of highest relevance to the query among the one or more selected terms based on frequency of occurrence and/or location of the selected one or more terms in a document.

33. The client module of claim 24 wherein the search server implements a search engine on the Internet, and the searching module communicates with the search engine via the Internet for executing the enhanced search query and retuning search results to the client module.

34. The client module of claim 24 wherein the storage module maintains said user interest information in a table including: one or more rows, each row representing a document of interest to the user; one or more columns, each column representing a term of interest to the user, wherein an entry at the intersection of each row and column represents the relevance of the term at that row within the document at that column.

35. A system for information searching, comprising:
an information manager configured for obtaining information that represents user interest;
a term selector configured for determining one or more key terms from said user interest information;
an enhancer configured for enhancing a query based on one or more of the key terms for generating an enhanced query for searching; and
a searching module configured for sending the enhanced query to a searching server via a communication link and causing execution of the enhanced query on a search engine for searching and obtaining search results.

36. The system of claim 35, wherein the enhancer is configured for combining the query with one or more of the key terms.

37. The system of claim 36, wherein the information manager is configured for obtaining information that represents user interest by determining user interest information based on user context.

38. The system of claim 37, wherein the information manager is configured for obtaining information that represents user interest by determining user interest information based on the history of user access to information.

39. The system of claim 38, wherein the term selector is further configured for determining one or more key terms from said user interest information based on the query.

40. The system of claim 39, further including a similarity computation module configured for determining a similarity between terms in the query and terms in the user interest information.

41. The system of claim 40, wherein the term selector is further configured for selecting one or more terms having highest similarity among the terms in the user interest information, as said one or more key terms.

42. The system of claim 40, wherein the term selector is further configured for selecting one or more terms having highest similarity among the terms in the user interest information, determining terms of highest relevance to the query, among the selected one or more terms, and choosing among terms of highest similarity and highest relevance, as said one or more key terms.

43. The system of claim 40, wherein the user interest information includes a document of interest to the user, such that the term selector is further configured for determining terms of highest relevance to the query by determining one or more terms of highest relevance to the query among the one or more selected terms based on frequency of occurrence and/or location of the selected one or more terms in a document.
